(19) United States
(12) Patent Application Publication
(10) Pub. No.: US 2003/0072595 A1
(43) Pub. Date: Apr. 17, 2003

(54) Lighted computer keyboard

(76) Inventor: Ziad Al-Safar, Windsor (CA)

Correspondence Address: Christopher J. Fildes, Fildes & Outland, P.C., Suite 2, 20916 Mack Avenue, Grosse Pointe Woods, MI, 48236, US

(21) Appl. No.: 10/161,934

(22) Filed: Jun. 3, 2002

Related U.S. Application Data
(60) Provisional application No. 60/329,733, filed on Oct. 16, 2001.

(51) Int. Cl. B41J 5/14

(52) U.S. Cl. 400/490

(57) ABSTRACT

A keyboard for a personal computer includes a plurality of finger keys having indicia thereon and operable by contact for providing computer input. A light source illuminates the underside of the keys. In one embodiment the indicia on the finger keys is translucent allowing light to emanate from the indicia in the configuration of alpha-numeric characters represented on the keys and thereby be distinguishable in low-light settings. In another embodiment of the invention the indicia on the keys is opaque and the finger keys are translucent allowing light to emanate from the keys around the configuration of alpha-numeric characters represented on the keys and thereby be also distinguishable in low-light settings.

### CROSS REFERENCE TO RELATED APPLICATION

This application claims the benefit of U.S. Provisional Application No. 60/329,733, filed Oct. 16, 2001.

### TECHNICAL FIELD

This invention relates to a keyboard device of a personal computer and more particularly to a computer keyboard that emits light through each key.

### BACKGROUND OF THE INVENTION

Many computer users through choice or necessity work in areas with little or no ambient light. For instance, many design rooms are kept dimly lit to aid the viewer viewing designs on a computer screen. Also avid game players may prefer to keep the area around the computer dimly lit so that images on the screen appear sharper.

In these dimly lit environments it is often difficult to identify the keys on the computer keyboard.

### SUMMARY OF THE INVENTION

The present invention provides a computer keyboard that emits light through each key so that the key identifying indicia is illuminated. More particularly, the keyboard can be fabricated in essentially the same manner as a conventional keyboard with the addition of an internal lighting source incorporated into the keyboard such that light will shine out through each key, thus enabling a computer user to see the keys even when the level of ambient light around the computer is low. Such an arrangement in a laptop computer allows use without turning room lights on and disturbing a sleeping partner.

According to the invention a keyboard for a personal computer includes a plurality of finger keys having indicia thereon and operable by contact for providing computer input. A light source illuminates the underside of the keys. In one embodiment the indicia on the finger keys is translucent allowing light to emanate from the indicia in the configuration of alpha-numeric characters represented on the keys and thereby be distinguishable in low-light settings. In another embodiment of the invention the indicia on the keys is opaque and the finger keys are translucent allowing light to emanate from the keys around the configuration of alphanumeric characters represented on the keys and thereby be also distinguishable in low-light settings.

The keyboard can also include an on/off switch for the lighting means so that illumination of the keys can be controlled and thereby shut off when not needed.

These and other features and advantages of the invention will be more fully understood from the following detailed description of the invention taken together with the accompanying drawings.

### BRIEF DESCRIPTION OF THE DRAWINGS

In the drawings:

FIG. 1 is a schematic view of a keyboard constructed in accordance with one embodiment of the invention illustrating lighted generally opaque finger keys having translucent indicia;

FIG. 2 is a schematic view of a keyboard constructed in accordance with another embodiment of the invention illustrating lighted translucent finger keys having opaque indicia;

FIG. 3 is a schematic plan view partially in section of a keyboard having a light source and using a fiber optic conductor to transport light from the light source to the keyboard keys; and

FIG. 4 is a schematic sectional elevational view of the keyboard of FIG. 3.

### DETAILED DESCRIPTION OF THE INVENTION

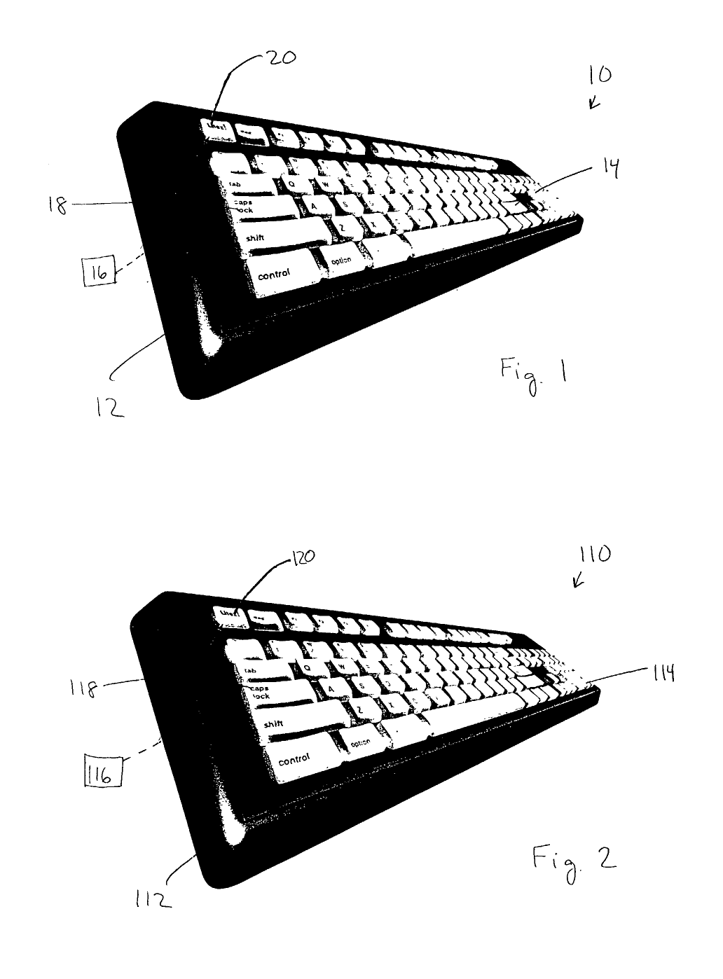

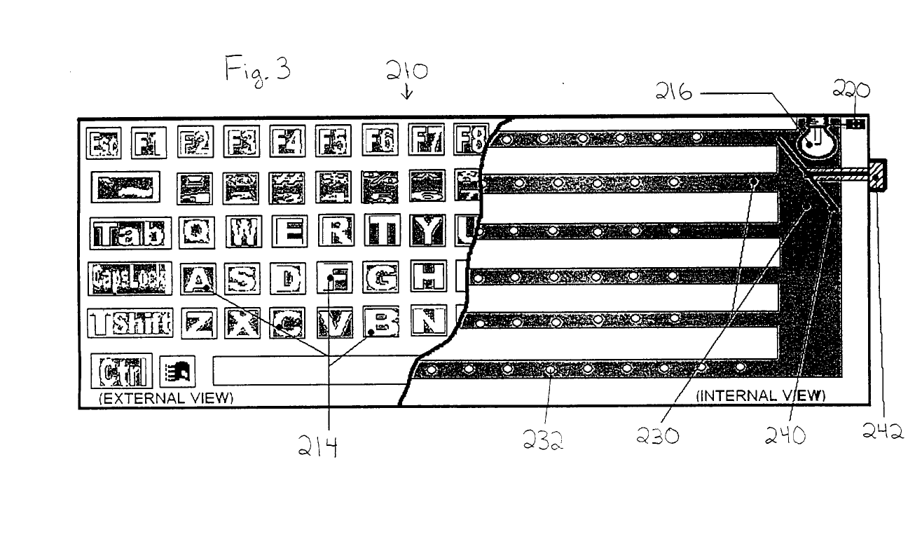

Referring now to the drawings, FIGS. 1 and 2 illustrate a keyboard 10, 110 for a personal computer, not shown. Keyboard 10, 110 can be a separate device as illustrated or may be built into a laptop or notebook computer. The function, layout and operation of keyboard 10, 110 is similar to that of keyboards of known construction in many respects. However and as herein is more fully described, keyboard 10, 110 includes a lighted finger key feature that allows for keyboard use in low-light settings.

In FIG. 1 keyboard 10 comprises a support 12 and a plurality of finger keys 14 supported by the support and operable by operator finger pressure to provide an input signal, such as an alpha-numeric input, to an associated desktop or laptop computer processor. Keyboard 10 includes a source of illumination or light means 16 therein which lights the back of the finger keys 14. The light means 16 can be an incandescent, fluorescent or other known light source and may emanate from a single source or multiple sources.

Each of the finger keys 14 include indicia 18, such as letters, numbers, punctuation marks and mathematical symbols, which is identifiable to the keyboard operator. When the associated finger key 14 is pressed, it provides a computer input corresponding to the indicia 18.

The indicia 18 of FIG. 1 are translucent and allow light from the light means 16 to emanate outwardly from the finger keys 14. In this embodiment the finger keys 14 are generally opaque. A switch 20 is provided in the support 12. Switch 20 is connected to the light means 16 and is operable to turn on and off the light source. When lighted, the finger keys 14 are easily distinguishable in low-light settings.

FIG. 2 illustrates a second embodiment of the keyboard 110. Herein similar characters refer to similar structures found in the first embodiment. The finger keys 114 are translucent and indicia 118 on the finger keys is opaque. When the light switch 120 is closed, and the light means 116 is illuminated, light is transmitted through the finger keys 114 except in the area marked by the indicia 118. In similar fashion to the herein above first embodiment, when lighted, the finger keys 114 are easily distinguishable in low-light settings.

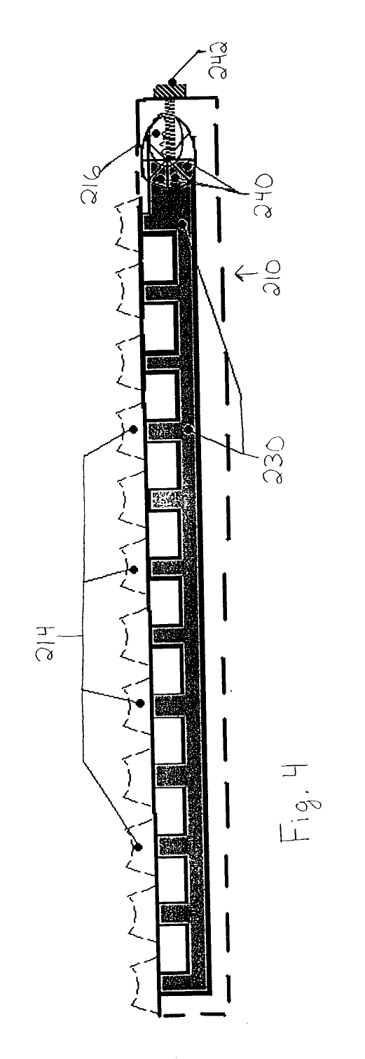

FIGS. 3 and 4 illustrate in detail one lighting embodiment for the keyboard 210 wherein the light means 216 illustrated is a light bulb mounted within the keyboard. Alternatively other types of a known lighting means such as an LED can be employed. A switch 220 is operable by an operator to connect a power source (not shown) to the light means 216 to turn the light means on and off. A fiber optic conductor 230 extends within keyboard 210 underneath the rows of finger keys 214 and transports light from the light means 216 when the light means 216 is illuminated. The fiber optic conductor 230 includes light emitting regions 232 associated with each finger key 214 to be illuminated. In accordance with the herein above described embodiments with respect to FIGS. 1 and 2 the finger keys 214 may be opaque and have transparent indicia or key characters. Alternatively, the finger keys 214 may be transparent and the indicia or key characters may be opaque.

With further reference to FIGS. 3 and 4, there is illustrated an optional structure that provides for different finger key colors.

Accordingly, a color wheel 240 can be disposed into the light path near the light means 216. Color wheel 240 includes color filters that colors the light emitted from the light means providing colored light that is transported through the fiber optic conductor 230 to the finger keys 214. A turn knob 242 disposed on the keyboard 210 is connected to the color wheel 240 to allow the color of the light to be changed to provide different key colors when used in an embodiment having transparent finger keys.

Although the invention has been described by reference to specific embodiments, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A keyboard for a personal computer, the keyboard including a plurality of finger keys having indicia thereon and operable by contact for providing computer input, the keyboard characterized by:
a light source illuminating the underside of the keys.

2. The keyboard of claim 1 characterized in that the indicia on the finger keys is translucent.

3. The keyboard of claim 1 is characterized in that the indicia on the keys is opaque and the finger keys are translucent.

4. A keyboard for a personal computer comprising:
a plurality of finger keys having light transmitting indicia; and
an internal source of illumination for illuminating the indicia.

5. The keyboard of claim 4 wherein the source of illumination is disposed about each finger key.

6. A keyboard for a personal computer comprising a light source operable for illuminating a plurality of finger keys on the keyboard.

7. The keyboard of claim 6 comprising a switch operable to allow switching between on and off states of the light source.

8. The keyboard of claim 1 wherein said light source includes a fiber optic conductor extending underneath rows of finger keys and an internal light means in light communication with the fiber optic conductor.

9. The keyboard of claim 8 wherein said light source is one of an incandescent lamp and LED.

10. The keyboard of claim 8 characterized in that said finger keys are translucent and the indicia thereon is opaque.

11. The keyboard of claim 8 characterized in that said finger keys are opaque and the indicia thereon is translucent.

12. The keyboard of claim 8 characterized in that a color wheel is disposed into the light path about said light source to color light emitted from the light source.

13. A keyboard for a personal computer, the keyboard including a plurality of finger keys having indicia thereon and operable by contact for providing computer input, the keyboard characterized by:
a fiber light source mounted inside the keyboard;
a fiber optic conductor extending underneath the finger keys and communicating light from said light source;
said fiber optic conductor including light emitting regions associated with each finger key; and
said finger keys being translucent and having opaque indicia thereon;
whereby illuminating said light source causes said finger keys to be thereby illuminated and the opaque indicia thereon easily identified in low light settings.

14. The keyboard of claim 13 further characterized by a color wheel disposed in the light path about said light source to color light emitted from the light source.

15. The keyboard of claim 14 further characterized by a turn knob disposed on the keyboard and connected to the color wheel to allow the color of the light to be changed.
